(19) United States
(12) Patent Application Publication
(10) Pub. No.: US 2006/0070242 A1
(43) Pub. Date: Apr. 6, 2006

(54) Shaving razors and razor cartridges

(76) Inventors: Andrew A. Szczepanowski, Walpole, MA (US); Robert A. Trotta, Pembroke, MA (US)

Correspondence Address: FISH & RICHARDSON P.C., P.O. BOX 1022, MINNEAPOLIS, MN, 55440-1022, US

(21) Appl. No.: 10/956,752

(22) Filed: Oct. 1, 2004

(51) Int. Cl. B26B 19/00; B26B 3/00

(52) U.S. Cl. 30/140; 30/34.05

(57) ABSTRACT

Razors are provided that include an electrical circuit configured to deliver heat to a portion of the razor housing. In some implementations, at least a portion of the circuit is disposed within the housing.

### TECHNICAL FIELD

This invention relates to shaving razors and razor cartridges, and more particularly to razors for wet shaving.

### BACKGROUND

Users of wet-shave razors generally appreciate a feeling of warmth against their skin during shaving. The warmth feels good, resulting in a more comfortable shave.

Various attempts have been made to provide a warm feeling during shaving. For example, shaving creams have been formulated to react exothermically upon release from the shaving canister, so that the shaving cream imparts warmth to the skin. Also, razor heads have been heated using hot air, heating elements, and linearly scanned laser beams, with power being supplied by a power source such as a battery.

### SUMMARY

The invention features razors that include a cartridge portion that is heated by an electrical circuit and is formed of a material that is capable of retaining heat and delivering heat to a user's skin.

In one aspect, the invention features a razor including (a) a handle, (b) a head, mounted on the handle, the head including a housing that is positioned to contact the user's skin during shaving and that carries one or more blades configured for wet shaving, and (c) an electrical circuit configured to deliver heat to at least a portion of the housing, the electrical circuit including a region of relatively higher resistance disposed within or adjacent to the head.

Some implementations may include one or more of the following features. At least part of the circuit may be disposed within the housing. At least the portion of the housing which is to be heated may include a polymer having a thermal conductivity of at least 1 W/m ° K, e.g., at least 3 W/m ° K. The electrical circuit may be configured to heat the housing to a surface temperature between about 40 and 70 degrees C., e.g., between about 32 and 55 degrees C. The electrical circuit may be configured to heat the razor for a time period of greater than 15 seconds. The circuit may be configured to heat a surface of the housing to a predetermined maximum temperature in a heating time of less than 20 seconds, e.g., less than 10 seconds. The razor may further include a power source, e.g., a battery, in electrical communication with the electrical circuit. The power source may be disposed within the handle. The power source may be rechargeable or disposable. The razor may be configured to be mounted in electrical communication with a recharging station. The razor may further include an indicator, visible to a user of the razor, constructed to provide a visual indication showing whether the razor is thermally charged, or indicating the degree to which the razor is thermally charged. The razor may also include a guard, and the guard may be formed of a thermally conductive polymer, e.g., a thermally conductive elastomer. The region of relatively high resistance may be disposed in the handle, adjacent to the housing. The head may be separable from the handle, and in some cases may be pivotally mounted thereon. The head may be mounted on the handle by an electromechanical pivot. A first portion of the housing may be formed of a thermally conductive polymer, and a second portion of the housing may be formed of a non-thermally conductive polymer. A third, exposed portion of the housing may be formed of a thermochromic polymer. The head may be configured to vibrate during shaving. The razor may include a motor and an oscillating member mounted on a shaft of the motor, so as to produce such vibration when the motor is energized.

In another aspect, the invention features a razor including a handle, a head, mounted on the handle, and, within the handle, an electrical circuit configured to deliver heat to at least a portion of the handle.

The invention also features razor cartridges that include one or more of the features discussed above. For example, the invention features a razor cartridge including (a) a head, constructed to be mounted on a handle, the head including a housing that is positioned to contact the user's skin during shaving and that carries one or more blades configured for wet shaving, and (b) a heating element disposed within the housing and configured for electrical communication with a power source disposed within the handle.

In some implementations, the cartridge also includes an electro-mechanical interconnect device, configured to interconnect the cartridge to a handle and to provide electrical communication between the cartridge and handle.

The invention also features razors that include a handle, a head, mounted on the handle, the head including a housing that is positioned to contact the user's skin during shaving and that carries one or more blades configured for wet shaving, a heat source configured to deliver heat to a portion of the housing, and a vibrating mechanism configured to impart vibration to the head.

The heat source may include, for example, an electrical circuit and/or a phase change material capable of storing and releasing latent heat from hot water.

The invention also features methods of shaving using the razors and cartridges discussed above.

The term “razor”, as used herein, unless otherwise indicated refers both to razors that include a handle and a replaceable cartridge, and to disposable razors in which the razor head is fixedly mounted on a handle.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a razor.

FIG. 2 is a diagrammatic front view of a razor according to one embodiment of the invention.

FIG. 3 is a diagrammatic front view of a razor according to an alternative embodiment of the invention. FIG. 3A is an enlarged, exploded front plan view of a cartridge and the upper portion of a handle suitable for use in the embodiment shown in FIG. 3.

FIG. 4 is a diagrammatic front view of another alternative embodiment of the invention.

FIG. 5 is an enlarged, exploded front plan view of a cartridge and the upper portion of a handle suitable for use in embodiments similar to that shown in FIG. 2.

FIG. 6 is a perspective view of a razor having a pivotally mounted cartridge. FIG. 6A is an enlarged, exploded detail view of the cartridge and the upper portion of the handle shown in FIG. 6.

FIG. 7 is a highly enlarged perspective view of the cartridge shown in FIGS. 6-6A, with the blades removed for clarity.

FIG. 8 is a highly enlarged perspective view of a clip/pivotal interconnect portion of the cartridge shown in FIG. 7.

FIG. 9 is a diagrammatic view showing a current path through the cartridge shown in FIGS. 6-7.

FIG. 10 is a diagrammatic view showing the current path through the clip/pivotal interconnect shown in FIG. 8.

FIG. 11 is a diagrammatic view of a razor according to another embodiment, including a control circuit.

### DETAILED DESCRIPTION

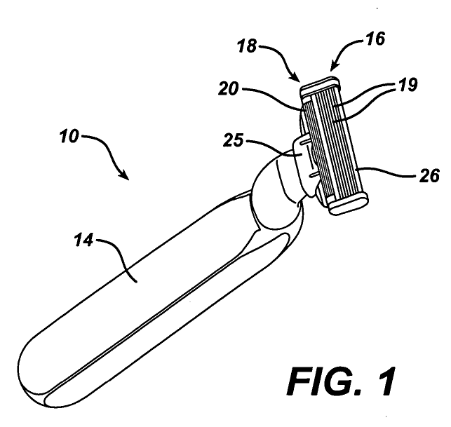

Referring to FIG. 1, a razor 10 includes a handle 14, and, mounted on the handle, a razor cartridge 16. Razor cartridge 16 includes a molded plastic housing 18, which carries a plurality of blades 19 and includes a guard 20. Cartridge 16 is removably mounted on handle 14 by an interconnect member 25. The housing 18 may be pivotally or rigidly (non-pivotally) mounted with respect to the handle, as will be discussed below.

Guard 20 includes a finned unit molded on the front of housing 16 to engage and stretch the user's skin; other skin engaging protrusions, e.g., as described in U.S. Pat. No. 5,191,712, which is hereby incorporated by reference, can be used. Guard 20 may be formed of elastomeric material, or may be formed of the same material as the rest of housing 16. Preferably, the fins are progressively taller toward the blades 19, so as to lift the hair gradually for a closer, more comfortable shave.

The razor cartridge 16 may also include other components that improve the performance or extend the life of the cartridge. For example, a piece of aluminum (not shown) may be included at one end to act as a sacrificial anode. Also, a shaving aid composite 26 may be provided at the upper edge of the housing 16 to deliver a lubricious substance to the user's skin, e.g., as described in U.S. Pat. Nos. 5,113,585 and 5,454,164, the disclosures of which are hereby incorporated by reference.

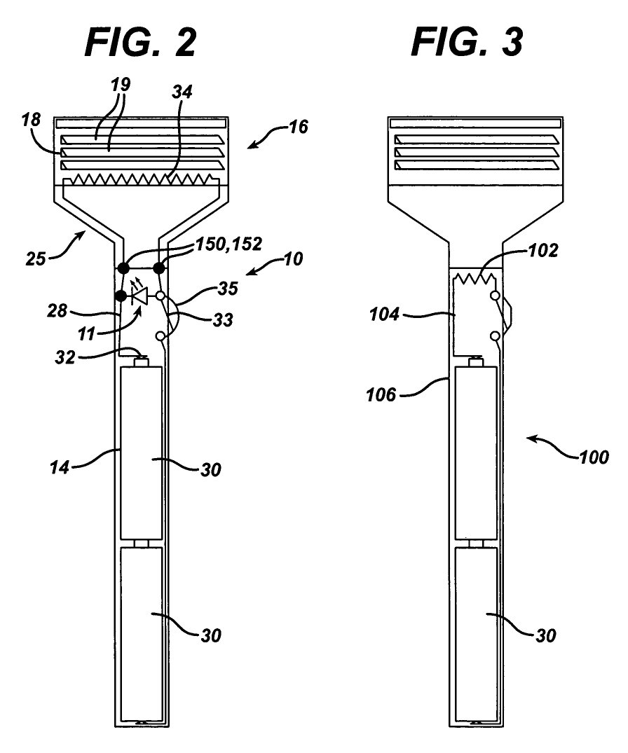

Referring to FIG. 2, in one embodiment the razor includes a circuit 28 to which current is supplied by one or more batteries, e.g., a pair of batteries 30, through a contact 32. The circuit is closed by a switch 33, which may be actuated by the consumer by pushing button 35. While the switch/button are on the side of the razor handle in the embodiment shown, they may be positioned elsewhere, e.g., at the bottom of the handle. An LED 11 is provided to indicate to the user that the power has been turned on. The LED may be disposed in a transparent area of the housing, or may extend through an opening in an opaque area of the housing. The LED may be positioned in an area of the razor other than that shown in FIG. 2, or may be omitted in some implementations.

The circuit includes a relatively high resistance area 34 (e.g., a resistor) embedded in the plastic housing 18, to provide heating in that area of the housing. Generally, this high resistance area is provided under the guard, as shown. It may, however, be provided in any desired area of the housing 18. When the high resistance area is provided under the guard, the guard may be formed of thermally conductive material, which may be overmolded with a thin (e.g., from about 0.1 to 0.5 mm thick) layer of a non-thermally conductive elastomer, i.e., an elastomer having a thermal conductivity of less than 1.0 W/m ° K, measured according to ASTM E1461 and F433. Suitable non-thermally conductive elastomers for this layer include, for example, KRATON block copolymers. If desired, the resistor may be embedded in the guard material, rather than in the housing, or relatively high resistance areas may be provided in both the guard and housing.

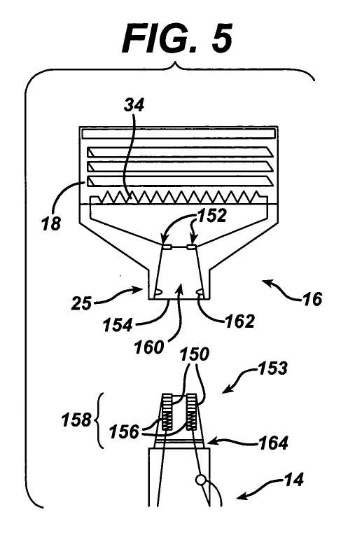

In the embodiment shown in FIG. 2, the cartridge is rigidly (non-pivotally) mounted on the handle. As shown in FIG. 5, current is transferred between the handle 14 and the cartridge 16 by engagement of mating contacts 150 on the handle and 152 on the cartridge. These contacts may be at the distal end 153 of the handle and the intersection of interconnect member 25 and housing 18, as shown in FIG. 5, or closer to the rim 154 of the interconnect member, as shown in FIG. 2. In the embodiment shown in FIG. 5, the contacts 150 are spring-loaded, i.e., biased toward the cartridge by springs 156. Also as shown in FIG. 5, the distal end 153 of the handle may include a generally frustro-conically shaped portion 158 and the cartridge may include a corresponding frustro-conical bore 160, to allow sliding engagement of the handle with the cartridge. Keyed features, e.g., a rib 162 on the wall of bore 160 and a circumferential groove 164 on portion 158, provide a secure yet removable engagement between the two parts.

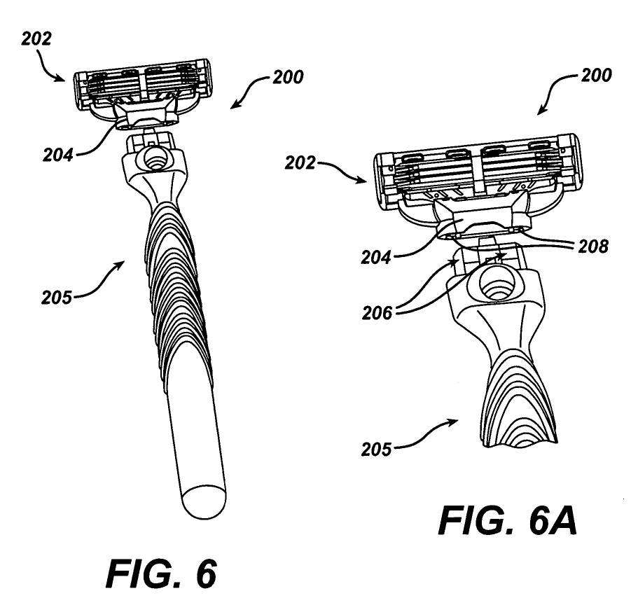

In some cases, for example in the razor 200 shown in FIGS. 6-6A, the electro-mechanical connection may be configured to allow the cartridge 202 to pivot with respect to the handle 205 while maintaining electrical communication between the portion of the circuit in the handle and the portion of the circuit in the cartridge. The electro-mechanical connection may include, for example, an electrically conductive plating (not shown) on the interconnect member 204, contacts 206 on the handle and corresponding contacts or other conductive features 208 on the cartridge (FIG. 6A).

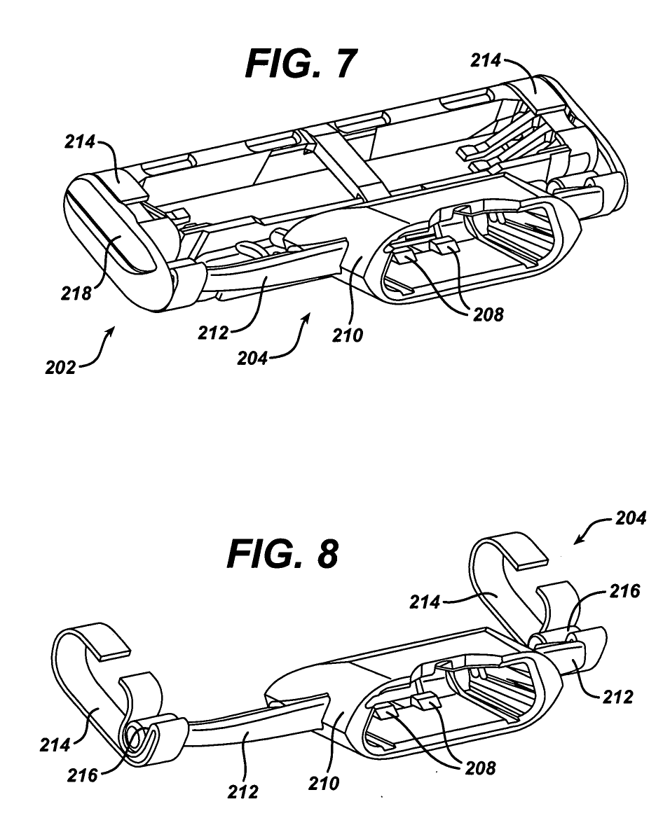

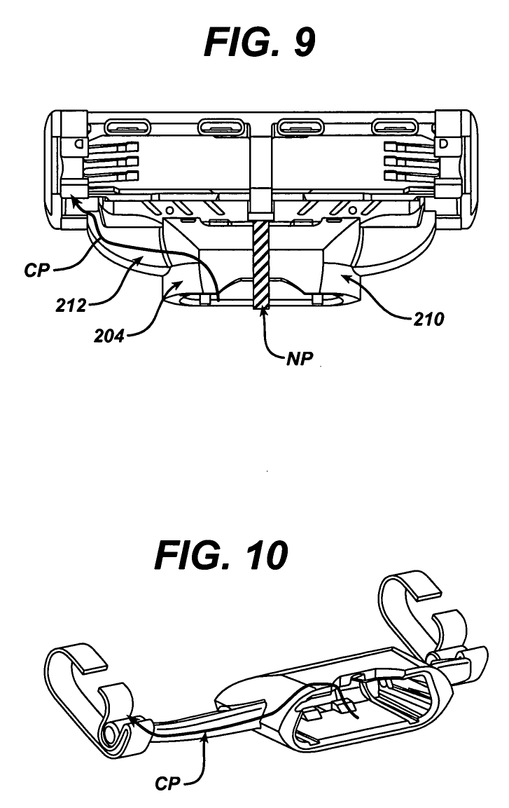

In the embodiment shown in FIGS. 6-7, the interconnect member 204, shown in detail in FIG. 8, includes a handle-receiving portion 210, which contains contacts 208, a pair of wings 212 that extend from the handle-receiving portion, and pair of clips 214 that are pivotally mounted on end portions 216 of the wings. As shown in FIG. 7, in the finished cartridge the clips 214 are crimped around the housing 218 both to hold the blades in place, as is well known in the razor field, and to provide a path for current (CP) from the contacts 208 through the interconnect member and to the housing (FIGS. 9 and 10). As indicated diagramatically in FIG. 9, all of the interconnect member is plated with the exception of area NP. This area serves to separate the current paths on the two sides of the interconnect member and prevent a short-circuit. Area NP can be provided, for example, by masking this area of the interconnect member during plating or by forming area NP of a plastic that does not plate well. The plated area may be plated, for example, with nickel or chromium. The plating may have a thickness of from about 0.001″ to 0.005″. Alternatively, the conductive path may be provided by other means, e.g., by insert molding lead wires into the plastic of the interconnect member.

In another alternative embodiment, the cartridge is integrally joined to the handle, rather than providing a separate interconnect member and an electromechanical connection. For example, the cartridge may be joined to the handle by a flexible web that is integral with the plastic housing 18 and integral with or molded onto the handle 14, with the circuit extending continuously from the handle through the cartridge, embedded in the web. In this case, the material of the plastic housing is preferably an elastomeric polymer having mechanical properties that allow the cartridge to pivot to a desired extent under normal use conditions.

The circuit may be provided in any desired manner, for example by the use of wires insert molded into the plastic of the housing and handle, or by a conductive path defined by an electrically conductive polymer co-molded with the plastic of the housing and handle. Suitable electrically conductive polymers include carbon and graphite filled polymers. Preferably, the electrically conductive polymer has a resistance of less than about 2 (10 E) ohms/sq measured according to ASTM D257.

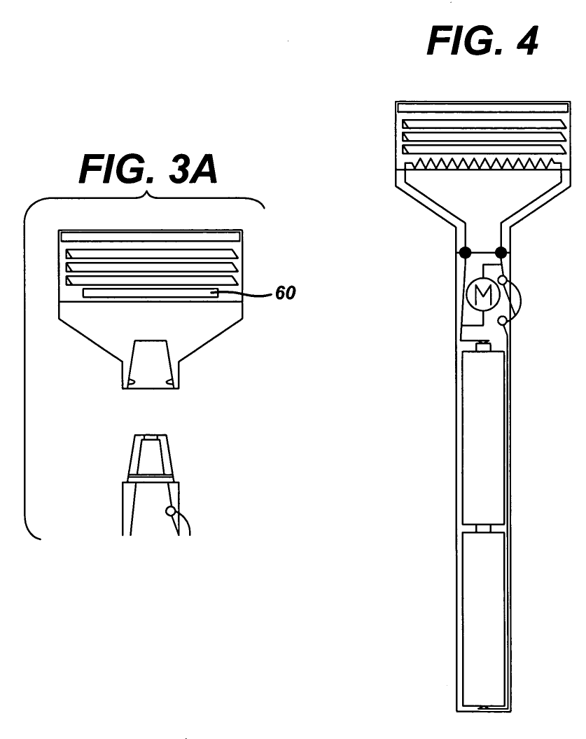

If desired, the razor handle can include a relatively high resistance portion of an electrical circuit, in addition to or instead of the relatively high resistance portion in the head. For example, referring to FIG. 3, in razor 100 handle 106 includes circuit 104 having a relatively high resistance portion 102 disposed in the handle adjacent the interconnect member 25. The high resistance portion 102 will heat the area of the handle adjacent the cartridge and the heat will conduct from the handle into the cartridge, thereby heating the cartridge without the need to provide electrical communication between the handle and cartridge.

It is generally preferred that the razor have a short “recharging time”, i.e., that the razor can be thermally charged by the circuit in a relatively short period of time. The razor is considered to be fully thermally charged when the surface of the cartridge reaches the desired temperature. Preferably, the recharging time is less than about 20 seconds, more preferably less than about 10 seconds. It is not necessary that the razor be fully thermally charged prior to use.

Another criteria in the design of the razor is the discharging interval, i.e., the time period during which the razor releases heat. The discharging interval may be measured by first fully charging the razor, then turning off the flow of current through the circuit, and then determining the length of time over which the surface temperature of the razor remains above a predetermined minimum, e.g., 40 degrees C. The discharging interval is preferably greater than 15 seconds, e.g., from about 15 seconds to 3 minutes, for a minimum temperature of 40 degrees C.

Discharging interval is dependent on the thermal conductivity of the material used to form the cartridge housing. Preferably, the plastic housing 18 is formed of a thermally conductive polymer. By “thermally conductive polymer,” we mean a polymer having a thermal conductivity, measured in watts/meter ° K (W/m ° K) of at least 1.0, measured according to ASTM E1461 and F433. Preferred polymers generally have a thermal conductivity of at least 1.0 W/m ° K, more preferably at least 1.2 W/m ° K and most preferably at least 3.0 W/m ° K. Suitable thermally conductive polymers include those available from Cool Polymers, Inc., Warwick, R.I., for example CoolPoly™ RS032 thermally conductive polypropylene (W/m ° K=10), and CoolPoly™ E8101/RS 083 thermally conductive elastomer (W/m ° K=15). When this combination of polymers is used, the polypropylene may be used to mold the cartridge housing, and the elastomer may be used to mold the elastomeric guard. Other suitable thermally conductive polymers from this supplier include CoolPoly™ RS 877 thermally conductive thermoplastic elastomer (W/m ° K=3.6), CoolPoly™ E2 thermally conductive liquid crystalline polymer (W/m ° K=20), CoolPoly™ E200 thermally conductive liquid crystalline polymer (W/m ° K=30), CoolPoly™ RB018 thermally conductive nylon 66 (W/m ° K=15), CoolPoly™ RB019 thermally conductive polycarbonate (W/m ° K=20), CoolPoly™ RB024, E Series, thermally conductive PC/ABS blend (W/m ° K=8), and CoolPoly™ RB020 thermally conductive PPS (W/m ° K=20.) Thermally conductive polymers are also commercially available from other sources, for example from LNP Engineered Plastics under the tradename KONDUIT. Other suitable thermally conductive polymers include polymers containing metal or ceramic fillers in a sufficient quantity to provide the desired level of thermal conductivity. Discharging interval is also dependent on the volume of this material; the more material, the longer the discharging interval will be. It is also desirable to design the cartridge such that it releases heat preferentially toward the face and at a rate that is just sufficient to maintain a sensation of warmth to the shaver.

It may be desirable to include an indicator that will provide a visual indication to the user of whether the razor is charged. Preferably, the indicator includes a thermochromic material that changes color in response to a temperature change. The indicator may include two or more different thermochromic materials that change color at different temperatures. For example, the indicator may include a first thermochromic material that turns blue when the razor head is at ambient temperature, a second thermochromic material that turns green when the razor head is within the desired temperature range, and a third thermochromic material that turns orange when the razor head is above the desired temperature range. Many other combinations of thermochromic materials may be used. Thermochromic materials can also be combined with non-thermochromic dyes and/or pigments to obtain desired colors.

The indicator may be in the form of a strip 60 that is mounted on or molded into the razor cartridge housing, as shown in FIG. 3A. In this case, different thermochromic materials may be positioned at intervals along the strip. The indicator may instead be in the form of discrete pads or areas of any desired shape. Alternatively, the indicator may be in the form of letters or other indicia that appear and disappear, e.g., “HOT” and “COLD”. Indicia may be provided, for example, by forming indicia that include thermochromic materials, or by providing non-thermochromic indicia that are obscured by a thermochromic coating that becomes translucent at a predetermined temperature. If desired, the indicator may be molded into the guard 20.

In other implementations, the thermochromic material may be compounded with the plastic of the razor head or cartridge housing. The thermochromic material may also be coated on the housing.

Although a thermochromic indicator is desirable from the standpoints of readability and simplicity, other indicators may be employed such as a liquid filled thermometer of various shapes or a compound bar type dial thermometer.

The razor may also include a vibrating feature, e.g., as indicated diagramatically in FIG. 4. Reciprocating, vibrating, or oscillating motion razors, referred to collectively herein as “vibrating razors,” are described, for example, in U.S. Pat. Nos. 5,046,249, 5,299,354, 5,794,342 and 6,481,104, the disclosures of which are incorporated herein by reference. As indicated in FIG. 4, the razor may include a rotary motor M, which may include an eccentric element for imparting oscillating motion. Motor M, e.g., an electric motor, is housed within the handle and has an output shaft (not shown) with an eccentric weight mounted thereon. Energization of the motor results in a high speed rotation of the eccentric weight and thereby vibration of the razor and the blade unit in particular. It is generally preferred that heat and vibration are delivered to the same area of the head at substantially the same time.

Other embodiments are within the scope of the following claims.

The thermally conductive material may be used in any desired part of the cartridge. For instance, both the guard and the cartridge housing may be formed of thermally conductive material, or the guard may be formed of thermally conductive material and some or all of the cartridge may be formed of non-thermally conductive material. If desired, a base portion of the cartridge housing may be molded of a non-thermally conductive plastic, and then a skin-contacting portion of the cartridge housing may be over-molded using a thermally conductive polymer. In this case, the thermally conductive polymer typically makes up from about 20 to 40% of the total thickness of the cartridge housing. For example, for a 4.5 mm thick cartridge, the thermally conductive layer may be from about 0.9 to 1.8 mm thick. A thin layer, e.g., about 0.1 to 0.5 mm thick, of a thermochromic polymer may be overmolded on top of the thermally conductive polymer to provide a temperature indicator. The cartridge may include three layers of polymer—a non-thermally conductive base portion, an intermediate layer of a thermally conductive polymer, and an outer, skin-contacting layer of a thermochromic polymer. The thermally conductive and/or thermochromic layers may be over molded, or may be attached to the base layer, e.g., by providing a frame of the overlying material that clips onto or is adhered onto the base layer.

If desired, the thermally conductive material may be omitted, and the cartridge made entirely of non-thermally conductive polymer.

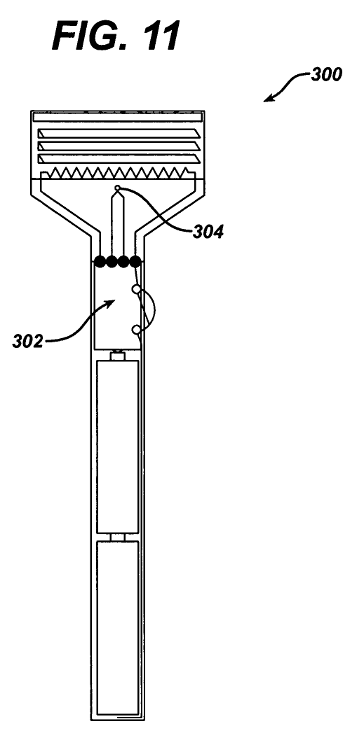

Moreover, in some embodiments, it may be desirable to include in the razor a control circuit for temperature regulation. An example of such a razor 300 is shown in FIG. 11. The control circuit 302 is configured to control the temperature by means of a temperature sensor 304. A dial or other control mechanism (not shown) may be provided to allow the user to manually adjust the temperature. The circuit may also include a pressure sensor (not shown). In this case, when the razor is placed against the skin the circuit, in response to a signal from the pressure sensor, supplies more power to the razor to overcome the heat sinking effects of soap, water and skin contact. Conversely, the circuit reduces power output when pressure is not detected, i.e., when the razor is not in contact with the skin, to prevent a thermal runaway. Thus, the razor is held at a reduced temperature when the power is on but the user is not shaving, so that when the user commences shaving again the razor temperature is not uncomfortably or dangerously hot.

Additionally, while certain razor designs have been shown and described above by way of example, the features described herein may be used in any desired razor design. For example, the features described above may be used in both men's and women's razors.

What is claimed is:

1. A razor comprising:
a handle,
a head, mounted on the handle, the head including a housing that is positioned to contact the user's skin during shaving and that carries one or more blades configured for wet shaving, and
an electrical circuit configured to deliver heat to at least a portion of the housing, the electrical circuit including a region of relatively higher resistance disposed within or adjacent to the head.

2. The razor of claim 1 wherein at least part of the circuit is disposed within the housing.

3. The razor of claim 1 wherein at least the portion of the housing which is to be heated includes a polymer having a thermal conductivity of at least 1 W/m.

4. The razor of claim 1 wherein the electrical circuit is configured to heat the housing to a surface temperature between about 40 and 70 degrees C.

5. The razor of claim 1 wherein the electrical circuit is configured to heat the housing to surface temperature between about 32 and 55 degrees C.

6. The razor of claim 1 wherein the electrical circuit is configured to heat the razor for a time period of greater than 15 seconds.

7. The razor of claim 1 wherein the circuit is configured to heat a surface of the housing to a predetermined maximum temperature in a heating time of less than 20 seconds.

8. The razor of claim 7 wherein the heating time is less than 10 seconds.

9. The razor of claim 1 further comprising a power source in electrical communication with the electrical circuit.

10. The razor of claim 9 wherein the power source comprises a battery.

11. The razor of claim 9 wherein the power source is disposed within the handle.

12. The razor of claim 9 wherein the power source is rechargeable.

13. The razor of claim 12 wherein the razor is configured to be mounted in electrical communication with a recharging station.

14. The razor of claim 1 further comprising an indicator, visible to a user of the razor, constructed to provide a visual indication showing whether the razor is thermally charged.

15. The razor of claim 14 wherein the indicator comprises a color change.

16. The razor of claim 14 wherein the indicator includes a thermochromic material.

17. The razor of claim 14 wherein the indicator includes an area positioned on the razor head.

18. The razor of claim 14 wherein the indicator includes a thermochromic material distributed through the material of the head or coated on a surface of the head.

19. The razor of claim 14 wherein the indicator is constructed to indicate the degree to which the razor is thermally charged.

20. The razor of claim 14 wherein the indicator includes a plurality of thermochromic materials having different color change temperatures.

21. The razor of claim 14 wherein the indicator displays an alphanumeric indicia or logo to indicate when the razor is thermally charged.

22. The razor of claim 21 wherein the indicia or logo appears when the razor is thermally charged.

23. The razor of claim 1 wherein a portion of the razor further includes a lubricating agent.

24. The razor of claim 1 wherein the razor further comprises a guard, and the guard is formed of a thermally conductive polymer.

25. The razor of claim 24 wherein the polymer comprises a thermally conductive elastomer.

26. The razor of claim 1 wherein the region of relatively high resistance is disposed in the handle, adjacent to the housing.

27. The razor of claim 2 wherein the head is separable from the handle and pivotally mounted thereon.

28. The razor of claim 27 wherein the head is mounted on the handle by an electromechanical pivot.

29. The razor of claim 28 wherein the electromechanical pivot includes pivot journals through which electrical communication takes place.

30. The razor of claim 29 wherein the pivot journals are plated.

31. The razor of claim 30 wherein a non-plated area is disposed between the pivot journals.

32. The razor of claim 1 wherein a first portion of the housing is formed of a thermally conductive polymer, and a second portion of the housing is formed of a non-thermally conductive polymer.

33. The razor of claim 32 wherein the housing further comprises a third, exposed portion formed of a thermochromic polymer.

34. The razor of claim 32 wherein the first portion comprises a skin-contacting portion of the housing, and the second portion underlies the first portion.

35. The razor of claim 33 wherein the second portion is interposed between the first and third portions.

36. The razor of claim 1 wherein the razor is configured to vibrate during shaving.

37. The razor of claim 36, wherein the razor further comprises a motor and an oscillating member mounted on a shaft of the motor, so as to produce vibration when the motor is energized.

38. The razor of claim 1 wherein the cartridge is integrally joined to the handle by a flexible web.

39. The razor of claim 38 wherein the web is integral with the housing and integral with or molded onto the handle.

40. The razor of claim 38 wherein the circuit extends continuously from the handle through the cartridge and is embedded in the web.

41. The razor of claim 29 wherein the electromechanical pivot includes lead wires embedded in the pivot journals.

42. The razor of claim 1, further comprising a control circuit for temperature regulation.

43. The razor of claim 42, further comprising a temperature sensor in communication with the control circuit.

44. The razor of claim 43, further comprising a control mechanism configured to allow the user to manually adjust the temperature of the housing.

45. The razor of claim 42, further comprising a pressure sensor, wherein the control circuit is configured to supply more power to the razor when pressure is detected, and reduce power output when pressure is not detected.

46. A razor comprising:
a handle,
a head, mounted on the handle, and,
within the handle, an electrical circuit configured to deliver heat to at least a portion of the handle.

47. A razor cartridge comprising
a head, constructed to be mounted on a handle, the head including a housing that is positioned to contact the user's skin during shaving and that carries one or more blades configured for wet shaving, and
a heating element disposed within the housing and configured for electrical communication with a power source disposed within the handle.

48. A razor comprising:
a handle,
a head, mounted on the handle, the head including a housing that is positioned to contact the user's skin during shaving and that carries one or more blades configured for wet shaving,
a heat source configured to deliver heat to a portion of the housing, and
a vibrating mechanism configured to impart vibration to the head.

49. The razor of claim 48 wherein the heat source comprises an electrical circuit.

50. The razor of claim 44 wherein the heat source comprises a phase change material capable of storing and releasing latent heat from hot water.

51. The razor of claim 44 wherein the heat source and vibrating mechanism are configured to deliver heat and impart vibration to the head substantially simultaneously.

52. The razor of claim 44 or 47 wherein the heat source and vibrating mechanism are configured to deliver heat and impart vibration to the same region of the head.
